(19) United States
(12) Patent Application Publication
(10) Pub. No.: US 2024/0411058 A1
(43) Pub. Date: Dec. 12, 2024

(54) LENS PANEL AND DISPLAY DEVICE INCLUDING THE SAME

(71) Applicant: SAMSUNG DISPLAY CO., LTD., YONGIN-SI (KR)

(72) Inventor: Young Sang HA, YONGIN-SI (KR)

(21) Appl. No.: 18/395,466

(22) Filed: Dec. 22, 2023

(30) Foreign Application Priority Data
Jun. 8, 2023 (KR) 10-2023-0073249

(51) Int. Cl. G02B 3/00; G02B 3/12; G02B 26/00; G02B 30/27

(52) U.S. Cl. CPC G02B 3/005; G02B 3/12; G02B 26/004; G02B 30/27

(57) ABSTRACT

A lens panel includes: a first lens array extending in a first direction, the first lens array including a first hole configured to transfer a fluid therethrough; and a second lens array extending in a second direction different from the first direction, the second lens array including a second hole configured to transfer the fluid therethrough.

### CROSS-REFERENCE TO RELATED APPLICATION

The present application claims priority under 35 U.S.C. § 119 (a) to Korean patent application No. 10-2023-0073249, filed on Jun. 8, 2023, in the Korean Intellectual Property Office, the entire disclosure of which is herein incorporated by reference.

### BACKGROUND

### 1. Technical Field

The present disclosure generally relates to a lens panel and a display device including the same, and more particularly to a lens panel that may display a 3D image that may be perceived at various viewpoints.

### 2. Discussion of Related Art

With the development of information technologies, the significance of a display device as a medium connecting a user with information has increased. Accordingly, the use of display devices, such as a liquid crystal display devices and an organic light emitting display devices, has increased.

A display device may generate an image having a three-dimensional (3D) effect by presenting two different images to a user, which simulate the way the user perceives depth in the real world. An image capable of providing the 3D effect to the user may be referred to as a stereoscopic image (3D image).

The display device may provide a physical factor such that the user perceives a planar image output by the display device as a 3D image. For example, the display device may provide different images to a left eye and a right eye of the user of the display device. The user may perceive the 3D effect of an image due to a binocular parallax between the left and right eyes.

One type of display device capable of generating an image having a 3D effect is a glass-free type display device. With the glass-free type display device, a user perceives a 3D image without wearing any 3D glasses. The glass-free type display device may include a lenticular type of display device in which a left eye image and a right eye image are separated from each other by using a cylindrical lens array, a barrier type in which a left eye image and a right eye image are separated from each other by using a barrier, and/or the like.

### SUMMARY

Embodiments provide a lens panel and a display device including the same, which can display a 3D image that may be perceived by a user at various viewpoints.

In accordance with an aspect of the present disclosure, there is provided a lens panel including: a first lens array extending in a first direction, the first lens array including a first hole configured to transfer a fluid therethrough; and a second lens array extending in a second direction different from the first direction, the second lens array including a second hole configured to transfer the fluid therethrough.

The first hole and the second hole may be connected, and the fluid discharged from the first hole of the first lens array may be injected into the second hole of the second lens array.

The first direction may be a column direction, and the second direction may be a row direction. The first lens array may include: a plurality of first variable lenses having a curvature varying as the fluid is injected into or discharged from the plurality of first variable lenses; and a first support plane configured to support the plurality of first variable lenses. The second lens array may include: a plurality of second variable lenses having a curvature varying as the fluid is injected into or discharged from the plurality of second variable lenses; and a second support plane configured to support the plurality of second variable lenses.

The lens panel may display a 3D image at a first viewing angle when the fluid is injected into the first lens array and when the fluid is discharged from the second lens array. The lens panel may display a 3D image at a second viewing angle when the fluid is discharged from the first lens array and when the fluid is injected into the second lens array.

The lens panel may display a planar image at a wide viewing angle when the fluid is discharged from the first lens array and the second lens array.

The lens panel may further include a fluid storage part configured to store the fluid. The fluid storage part may include: a tube connected to at least one of the first hole or the second hole; and a storage tank connected to the tube.

The tube may include: a first tube connected to the first hole; and a second tube connected to the second hole. The storage tank may be connected to each of the first tube and the second tube.

The lens panel may further include a pressurizing device configured to pressurize at least one of the first lens array and the second lens array. The pressurizing device may include: a pressurizing member on a top surface and a back surface of the lens panel; an elastic body configured to provide an elastic force; a motor configured to provide power for contracting the elastic body; a connection member configured to connect between the elastic body and the pressurizing member; and a fixing pin configured to selectively fix a position of the elastic body which is contracted or relaxed.

The pressurizing member may include: a first pressurizing member configured to pressurize the first lens array at a top surface of the first lens array; a second pressurizing member configured to pressurize the first lens array at a back surface of the first lens array or pressurize the second lens array at a top surface of the second lens array; and a third pressurizing member configured to pressurize the second lens array at a back surface of the second lens array. The elastic body may include: a first elastic body configured to provide an elastic force to the first pressurizing member and the second pressurizing member; and a second elastic body configured to provide an elastic force to the second pressurizing member and the third pressurizing member. The motor may include: a first motor configured to provide power for contracting the first elastic body; and a second motor configured to provide power for contracting the second elastic body.

The first hole may be disposed at an end of the first lens array in the first direction, and the second hole may be disposed at an end of the second lens array in the second direction.

The first lens array may include a plurality of first variable lenses, the second lens array may include a plurality of second variable lenses, and the first hole may be disposed at a back surface of the first lens array, and the second hole may be disposed at a top surface of the second lens array.

The first lens array may include a plurality of first holes including the first hole, and the second lens array may include a plurality of second holes including the second hole. A number of the plurality of first holes and a number of the plurality of second holes may be a same number, and the same number may correspond to a value obtained by multiplying a number of the plurality of first variable lenses and a number of the plurality of second variable lenses.

The first lens array may include a plurality of first holes including the first hole, and the second lens array may include a plurality of second holes including the second hole. Each of the plurality of first holes may correspond to any one of the plurality of first variable lenses, and correspond to any one of the plurality of second variable lenses. Each of the plurality of second holes may correspond to any one of the plurality of first variable lenses, and correspond to any one of the plurality of second variable lenses. The plurality of first holes and the plurality of second holes may be disposed aligned in a diagonal direction.

The fluid may include a polymer having a refractive index between about 1.5 and about 1.7.

In accordance with another aspect of the present disclosure, there is provided a display device including: a display panel including a display area in which a plurality of pixels are disposed and a non-display area at a periphery of the display area; and a lens panel overlapped with the display panel, wherein the lens panel includes: a first lens array extending in a first direction, the first lens array including a first hole configured to transfer a fluid therethrough; and a second lens array extending in a second direction different from the first direction, the second lens array including a second hole configured to transfer the fluid therethrough.

The first direction may be a column direction, and the second direction may be a row direction. The first lens array may include: a plurality of first variable lenses overlapped with the display area, the plurality of first variable lenses having a curvature varying as the fluid is injected into or discharged from the plurality of first variable lenses; and a first support plane configured to support the plurality of first variable lenses. The second lens array may include: a plurality of second variable lenses overlapped with the display area, the plurality of second variable lenses having a curvature varying as the fluid is injected into or discharged from the plurality of second variable lenses; and a second support plane configured to support the plurality of second variable lenses.

The display device may further include a fluid storage part configured to store the fluid. The fluid storage part may include: a tube connected to at least one of the first hole or the second hole; and a storage tank connected to the tube. The tube and the storage tank may be overlapped with the non-display area. A back cover may be located on a back surface of the display panel, the back cover may include the non-display area of the display panel, which may be accommodated therein. The back cover may accommodate the fluid storage part.

The display device may further include a pressurizing device configured to pressurize at least one of the first lens array and the second lens array. The pressurizing device may include: a pressurizing member on a top surface and a back surface of the lens panel; an elastic body configured to provide an elastic force; a motor configured to provide power for contracting the elastic body; a connection member configured to connect between the elastic body and the pressurizing member; and a fixing pin configured to selectively fix a position of the elastic body that is contracted or relaxed. A back cover may be located on a back surface of the display panel, the back cover may include the non-display area of the display panel, which may be accommodated therein. The back cover may accommodate the pressurizing device. In accordance with an aspect of the present disclosure, there is provided a lens panel including: a first lens array including a plurality of first variable lenses extending in a first direction and including a first elastic body having light transmissivity; and a second lens array including a plurality of second variable lenses extending in a second direction and including a second elastic body having light transmissivity.

The first direction may be a column direction and the second direction may be a row direction. The plurality of first variable lenses may have a curvature varying as a fluid is injected to or discharged from the plurality of first variable lenses. The plurality of second variable lenses may have a curvature varying as the fluid is injected to or discharged from the plurality of second variable lenses.

### BRIEF DESCRIPTION OF THE DRAWINGS

FIG. 1 is a conceptual view illustrating a display device in accordance with embodiments of the present disclosure.

FIG. 2 is a view illustrating a 3D image displayed at a first viewpoint by the display device shown in FIG. 1 in accordance with embodiments of the present disclosure.

FIG. 3 is a view illustrating a blurred image displayed at a second viewpoint by the display device shown in FIG. 1 in accordance with embodiments of the present disclosure.

FIG. 4 is a view illustrating a 3D image displayed at a second viewpoint by the display device shown in FIG. 1 in accordance with embodiments of the present disclosure.

FIG. 5 is an example of a lens array set in accordance with embodiments of the present disclosure.

FIG. 6A and FIG. 6B are views illustrating a first lens array shown in FIG. 5.

FIG. 7A and FIG. 7B are views illustrating a second lens array shown in FIG. 5.

FIG. 8 is an embodiment of a first viewing angle lens array set using the lens array set shown in FIG. 5.

FIG. 9 is an embodiment of a second viewing angle lens array set using the lens array set shown in FIG. 5.

FIG. 10 is an embodiment of a wide viewing angle lens array set using the lens array set shown in FIG. 5.

FIG. 11 is an example of a fluid storage part in accordance with embodiments of the present disclosure.

FIG. 12 is a view illustrating the fluid storage part shown in FIG. 11 in accordance with embodiments of the present disclosure.

FIG. 13 is an example of a pressurizing device in accordance with embodiments of the present disclosure.

FIG. 14 is a view illustrating the pressurizing device shown in FIG. 13 in accordance with embodiments of the present disclosure.

FIG. 15 is an embodiment of the first viewing angle lens array set using the lens array set shown in FIG. 5.

FIG. 16 is an embodiment in which a plurality of first holes are provided at a back surface of the first lens array shown in FIG. 5.

FIG. 17 is an embodiment in which a plurality of second holes corresponding to the plurality of first holes shown in FIG. 16 are provided at a top surface of the second lens array shown in FIG. 5.

FIG. 18 is an embodiment in which a plurality of first holes are provided at the back surface of the first lens array shown in FIG. 5.

FIG. 19 is an embodiment in which a plurality of second holes corresponding to the plurality of first holes shown in FIG. 18 are provided at the top surface of the second lens array shown in FIG. 5.

### DETAILED DESCRIPTION

Example embodiments will now be described more fully hereinafter with reference to the accompanying drawings; however, they may be embodied in different forms and should not be construed as limited to embodiments set forth herein. Rather, embodiments are provided so that this disclosure will be thorough and complete, and will fully convey the scope of the present disclosure to those skilled in the art.

In the drawing figures, dimensions may be exaggerated for clarity of illustration. It will be understood that when an element is referred to as being “between” two elements, it can be the only element between the two elements, or one or more intervening elements may also be present.

The same or similar constituent elements will be designated by the same reference numerals throughout the specification. The same reference numerals may be used in different drawings to identify the same or similar elements. Repetitive descriptions of the same or similar elements may be omitted to clearly describe the present disclosure.

In addition, the size and thickness of each component illustrated in the drawings may be arbitrarily shown for better understanding and ease of description, but the present disclosure is not limited thereto. Thicknesses of several portions and regions may be exaggerated for clear expressions.

In description, the expression “same” may mean “substantially the same”. The expression “same” may mean equality to a degree to which those skilled in the art can understand the equality. Other expressions may omit “substantially”.

It will be understood that, although the terms “first”, “second”, etc. may be used herein to describe various elements, these elements should not be limited by these terms. These terms are only used to distinguish one element from another element. Thus, a “first” element discussed below could also be termed a “second” element without departing from the teachings of the present disclosure. As used herein, the singular forms are intended to include the plural forms as well, unless the context clearly indicates otherwise.

The terms “under”, “beneath”, “on”, “above”, and the like may be used to describe a relationship between components illustrated in a drawing. The terms are relative and are described with reference to a direction indicated in the drawing.

The terminology used herein is for the purpose of describing aspects of the present disclosure and is not to be construed as limiting the inventive concept. Unless defined otherwise, it is to be understood that all the terms (including technical and scientific terms) used in the specification has the same meaning as those that are understood by those who skilled in the art.

It will be further understood that the terms “including” and/or “comprising”, when used in this specification, specify the presence of stated features, integers, steps, operations, elements, and/or components, but do not preclude the presence and/or addition of one or more other features, integers, steps, operations, elements, components, and/or groups thereof.

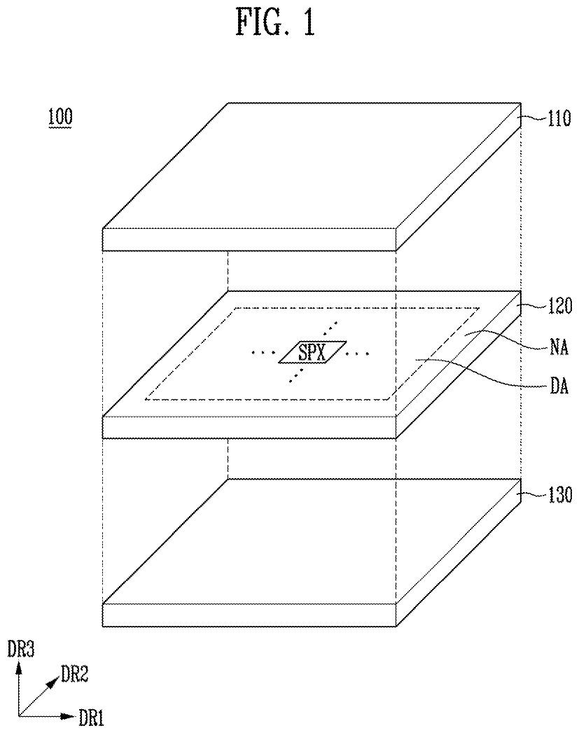

FIG. 1 is a conceptual view illustrating a display device 100 in accordance with embodiments of the present disclosure.

The display device 100 in accordance with embodiments of the present disclosure may include a lens panel 110, a display panel 120, and a back cover 130. The display device 100 may include additional elements.

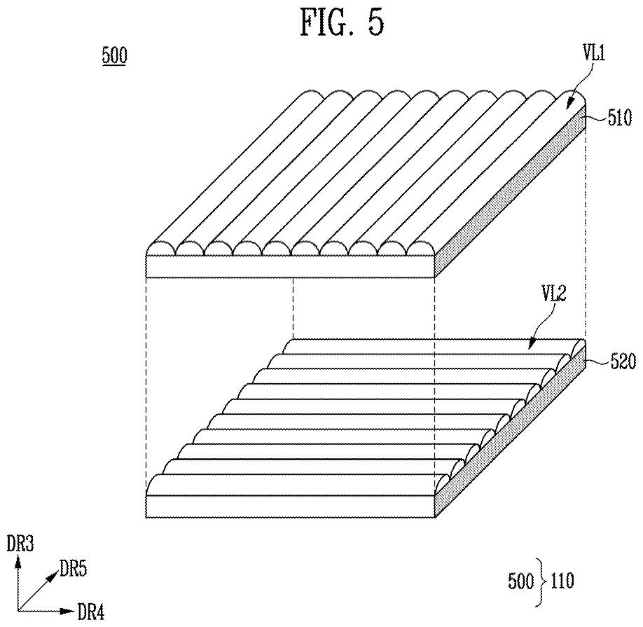

The lens panel 110 may be configured to control an intensity and a direction of light emitted from the display panel 120. The lens panel 110 may include at least one lens, and a user of the display device 100 may perceive, as a 3D image, an image emitted from the display panel 120. The lens panel 110 in accordance with embodiments of the present disclosure will be described in more detail with reference to FIG. 5.

The display panel 120 may include a display area DA and a non-display area NA located at the periphery of the display area DA (e.g., an edge area of the display area DA). The display area DA may extend in a first direction DR1 and a second direction DR2 intersecting the first direction DR1. The display panel 120 may include a plurality of sub-pixels SPX. Each of the plurality of sub-pixels SPX may emit light. Each of the plurality of sub-pixels SPX may emit light of a predetermined wavelength. Each of the plurality of sub-pixels SPX may emit light in a predetermined range of wavelengths. The plurality of sub-pixels SPX may be arranged in the display area DA. For example, a plurality of sub-pixels SPX arranged along the first direction DR1 may constitute a pixel row. For example, a plurality of sub-pixels SPX arranged along the second direction DR2 may constitute a pixel column.

The display panel 120 in accordance with embodiments of the present disclosure may include a light emitting layer configured to generate light and emit the generated light. The light emitting layer may include, for example, an organic light emitting layer, a quantum dot, an inorganic light emitting layer, and the like. According to a kind of light emitting layer included in the display panel 120, the display device 100 may be implemented as a self-luminous display device such as an organic light emitting display device, a quantum dot display device, or an inorganic light emitting display device.

The display panel 120 in accordance with embodiments of the present disclosure may be configured to allow light incident from the outside to be selectively reflected therefrom without directly generating light. For example, the display device 100 in accordance with embodiments of the present disclosure may include a light source (e.g., a backlight unit or the like) at the outside of the display panel 120. The display panel 120 may include, for example, liquid crystals configured to control the intensity of light emitted from the display panel 120. The display panel 120 may control the intensity of light emitted from display panel 120 by adjusting a tilting angle or the like of the liquid crystals. In an embodiment in which the display panel 120 does not include the light emitting layer, the display device 100 may be implemented as a passive light emitting display device.

Hereinafter, for convenience of description, an embodiment in which the display device 100 is a self-luminous display device is described as an example. However, embodiments of the present disclosure are not limited thereto.

The sub-pixel SPX may include a light emitting element and a pixel circuit for driving the light emitting element. The pixel circuit may include, for example, two or more transistors and at least one capacitor.

The display panel 120 may include a substrate, a thin film transistor layer in which the pixel circuit is formed, and a light emitting element layer in which the light emitting element is located. The substrate may include a glass substrate, an organic and/or inorganic complex material substrate, or the like. The substrate may support the thin film transistor layer and the light emitting element layer. For example, the thin film transistor layer and the light emitting element layer may be sequentially disposed on the substrate.

A panel driving circuit (not shown) for supplying various signals and/or various voltages, which are used to drive the sub-pixel SPX, may be connected to the display panel 120. The panel driving circuit may be connected (e.g., electrically connected) to a pad part and the like, provided in the non-display area NA, to supply signals, voltages, and the like to the display panel 120.

The back cover 130 may be located on a back surface of the display panel 120. The panel driving circuit connected to the display panel 120 may be accommodated in the back cover 130. In some embodiments, a portion of the panel driving circuit may be bent to the back surface of the display panel 120, the panel driving circuit may be accommodated in the back cover 130.

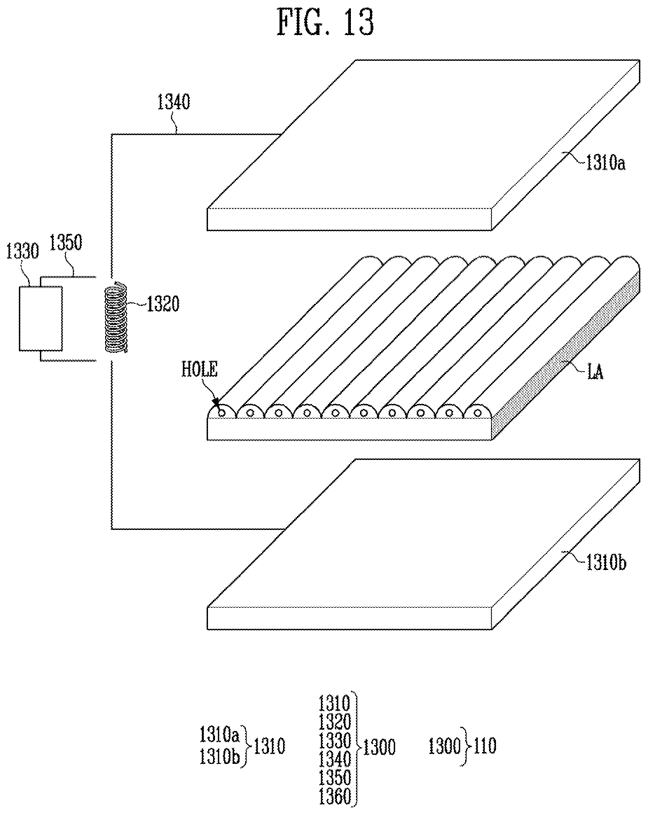

In some embodiments, the back cover 130 may accommodate at least a portion of the lens panel 110. For example, a fluid storage part 1100 described in FIG. 11, a pressurizing device 1300 described in FIG. 13, and/or the like may be accommodated in the back cover 130 (e.g., accommodated in a space between the display panel 120 and the back cover 130).

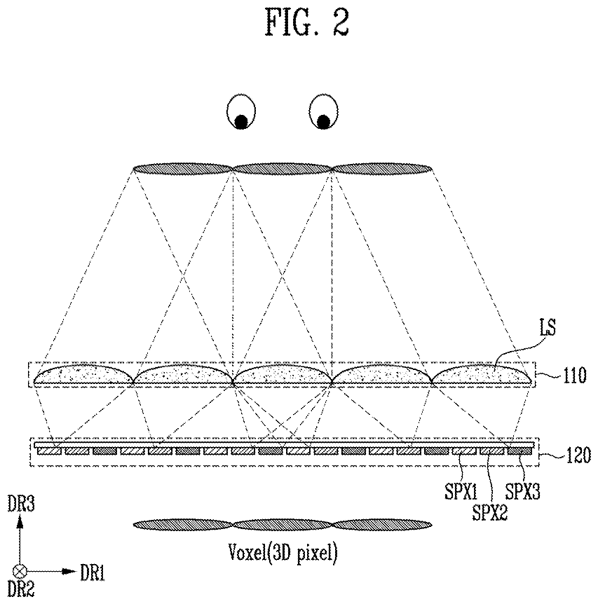

FIG. 2 is a view illustrating a 3D image displayed at a viewpoint by the display device 100 shown in FIG. 1 in accordance with embodiments of the present disclosure.

The display panel 120 may include a plurality of sub-pixels SPX1, SPX2, and SPX3 which may display an image by emitting light. In an embodiment, each of the plurality of sub-pixels SPX1, SPX2, and SPX3 may output one of light in a first range of wavelengths (e.g., a red wavelength band), light in a second range of wavelengths (e.g., a green wavelength band), or light in a third range of wavelengths (e.g., a blue wavelength band). The red wavelength band may be a range of wavelengths from about 600 nm (nanometer) to about 750 nm, the green wavelength band may be a range of wavelengths from about 480 nm to about 560 nm, and the blue wavelength band may be a range of wavelengths from about 370 nm to about 460 nm. However, embodiments of the present disclosure are not limited thereto. The present description is illustrative, and the wavelength band of light emitted from each of the plurality of sub-pixels SPX1, SPX2, and SPX3 is not limited thereto. Light of various colors may be output. The plurality of sub-pixels SPX1, SPX2, and SPX3 emitting light in different wavelength bands may constitute one pixel.

The lens panel 110 may be disposed above the display panel 120 (e.g., an area in a third direction DR3 from the display panel 120). The lens panel 110 may include a plurality of lenses LS configured to refract light incident from the plurality of sub-pixels SPX1, SPX2, and SPX3. The plurality of lenses LS may constitute a lens array. The lens array may be implemented as, for example, a lenticular lens array, a micro lens array, or the like. The plurality of lenses LS may be disposed in the lens panel 110 while extending in the second direction DR2.

The display device 100 (see FIG. 1) in accordance with embodiments of the present disclosure may be implemented as a light field display. The light field display may be a 3D display that generates a 3D image by forming a light field expressed with a vector distribution (intensity and direction) of light in a space, using a flat panel display (e.g., the display panel 120) and an optical element (e.g., the lens panel 110). The light field display refers to a display technique in which a depth, a side, and/or the like of an object can be viewed, so that a 3D image can be implemented. The light field display may display a natural 3D image, which may be implemented in various use cases including, for example, an Augmented Reality (AR) system, and/or the like.

The light field may be implemented using various methods. For example, the light field may be formed using a method of making light fields in several directions, using several projectors, a method of controlling a direction of light, using a grating, a method of controlling a direction and an intensity (luminance) of light according to a combination of a plurality of sub-pixels, using two or more panels, a method of controlling a direction of light, using a pinhole or a barrier, a method of controlling a refraction direction of light through a lens array, or the like.

In an embodiment, as shown in FIG. 2, the display device 100 (see FIG. 1) using a lens array method may form a light field, thereby displaying a stereoscopic image that may be perceived as a 3D image. Generally, a stereoscopic image display technique displays a stereoscopic image by dividing a stereoscopic image frame into a left image frame and a right image frame, and providing the left image frame and the right image frame to the user, and more particularly to a left eye and a right eye, respectively.

Using a lens array method, at least one sub-pixel SPX may be allocated to each lens LS of the lens panel 110. Light emitted from the sub-pixel SPX may be refracted by the lens LS to travel in a specific direction, thereby forming a light field expressed with an intensity and a direction of the light. When the user of the display device 100 (see FIG. 1) views the display device 100 in the light field formed as described herein, the user may perceive a 3D effect of a corresponding image.

Image information according to a viewpoint of a viewer within the light field may be defined and processed in units of voxels. The voxel may be understood as graphic information that defines a predetermined point (or pixel) in a 3D space. A resolution of a 2D image may be decided using a number (e.g., a density) of pixels (or sub-pixels SPX) with respect to a given area. For example, when the number of pixels (or sub-pixels SPX) in an area increases, the resolution may increase. That is, a pixel density of the display panel 120 may be related to a resolution of an image displayed by the display device 100. Similarly, the number of voxels at a same viewpoint through the lens panel 110 may be related to the resolution of a 3D image. For example, the resolution of the image displayed by the display device may increase with the number of voxels at the same viewpoint.

The plurality of lenses LS in the lens panel 110 may extend in a direction (e.g., the second direction DR2). Accordingly, the user of the display device 100 (see FIG. 1) at a viewpoint shown in FIG. 2 can perceive the 3D effect of an image.

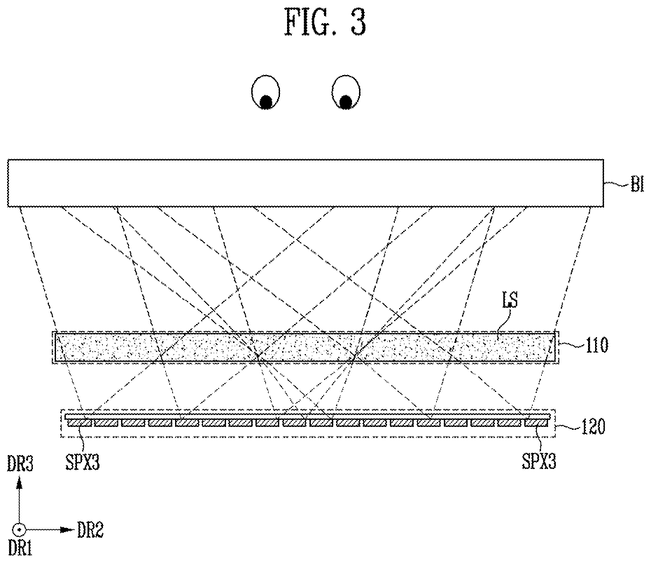

FIG. 3 is a view illustrating a blurred image BI that may be displayed by the display device 100 shown in FIG. 1 and perceived at a second viewpoint in accordance with embodiments of the present disclosure.

Referring to FIG. 3, an example in which an image displayed by the display device 100 shown in FIG. 1 may be viewed at a viewpoint different from the viewpoint shown in FIG. 2. At the viewpoint shown in FIG. 3, the lens LS of the lens panel 110 may extend in the second direction DR2 and it may be difficult to form a clear image through light emitted from the display panel 120. Accordingly, a blurred image BI may be formed and viewed by the user of the display device 100.

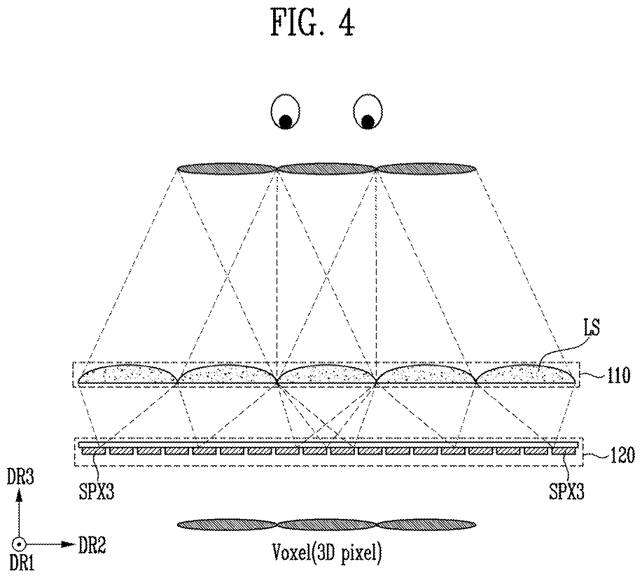

FIG. 4 is a view illustrating a 3D image displayed by the display device 100 shown in FIG. 1 and perceived by the user at the second viewpoint in accordance with embodiments of the present disclosure.

Referring to FIG. 4, an example in which the display device 100 shown in FIG. 1 is viewed from the same viewpoint as FIG. 3 is exemplarily illustrated. The lens panel 110 shown in FIG. 4 may include the plurality of lenses LS that may extend in the first direction DR1. Light emitted from the display panel 120 may be refracted by the lens panel 110, so that a clear image can be viewed by the user of the display device 100.

Referring to FIG. 2, FIG. 3, and FIG. 4, as the direction in which the lenses LS of the lens panel 110 extend adaptively varies, the user of the display device 100 (see FIG. 1) can perceive the 3D effect of an image at various viewpoints. In embodiments of the present disclosure, the lens panel 110 can be provided, in which the lens LS extends in any direction selected from two or more directions (e.g., the first direction DR1 and the second direction DR2). A specific embodiment of the lens panel 110 for implementing this will be described herein.

FIG. 5 is an example of a lens array set 500 in accordance with embodiments of the present disclosure.

Referring to FIG. 5, the lens panel 110 in accordance with embodiments of the present disclosure may include a lens array set 500. The lens array set 500 may include a first lens array 510 and a second lens array 520.

The first lens array 510 may include a first variable lens VL1 extending in a fifth direction DR5. The second lens array 520 may include a second variable lens VL2 extending in a fourth direction DR4. The fourth direction DR4 and the fifth direction DR5 may be different from each other. For example, the fourth direction DR4 and the fifth direction DR5 may be perpendicular to each other.

The fourth direction DR4 and the fifth direction DR5 may be directions perpendicular to each other, but embodiments of the present disclosure are not limited thereto. For example, an angle formed by the fourth direction DR4 and the fifth direction DR5 may be a right angle, an acute angle, or an obtuse angle. Hereinafter, for convenience of description, a case where the fourth direction DR4 and the fifth direction DR5 are perpendicular to each other is described as an example, but embodiments of the present disclosure are not limited thereto.

The fourth direction DR4 may be, for example, the same as the first direction DR1 (see FIG. 1), the second direction DR2 (see FIG. 1), or the like, but embodiments of the present disclosure are not limited thereto. The fifth direction DR5 may be, for example, the same as the second direction DR2 (see FIG. 1), the first direction DR1 (see FIG. 1), or the like, but embodiments of the present disclosure are not limited thereto. Hereinafter, for convenience of description, a case where the fourth direction DR4 is a row direction as the same direction as the first direction DR1 and where the fifth direction DR5 is a column direction as the same direction as the second direction DR2 is described as an example. However, embodiments of the present disclosure are not limited thereto.

The first lens array 510 and the second lens array 520 may overlap each other. For example, referring to FIG. 5, the first lens array 510 and the second lens array 520 may overlap each other in the third direction DR3. For example, the first lens array 510 may be disposed on the second lens array 520. The third direction DR3 may be a direction perpendicular to both the fourth direction DR4 and the fifth direction DR5.

Each of the first variable lens VL1 and the second variable lens VL2 may be selectively activated or deactivated.

For example, when the first variable lens VL1 is activated, the first variable lens VL1 may serve as a lens that refracts light with a predetermined curvature (e.g., a curvature greater than 0). For example, the activated first variable lens VL1 may serve as a lens LS capable of displaying a 3D image at a first viewpoint as shown in FIG. 2. For example, when the first variable lens VL1 is deactivated, the deactivated first variable lens VL1 may serve as a window having no curvature (or may be substantially flat).

For example, when the second variable lens VL2 is activated, the second variable lens VL2 may serve as a lens which refracts light with a predetermined curvature (e.g., a curvature greater than about 0). For example, the activated second variable lens VL2 may serve as a lens LS capable of displaying a 3D image at a second viewpoint as shown in FIG. 4. For example, when the second variable lens VL2 is deactivated, the deactivated second variable lens VL2 may serve as a window having no curvature (or may be substantially flat).

The first variable lens VL1 and the second variable lens VL2 may be selectively activated. For example, when the first variable lens VL1 is activated, the second variable lens VL2 may be deactivated. For example, when the second variable lens VL2 is activated, the first variable lens VL1 may be deactivated. For example, both the first variable lens VL1 and the second variable lens VL2 may be deactivated.

When the first variable lens VL1 is activated and the second variable lens VL2 is deactivated, the lens array set 500 may serve as the lens LS shown in FIG. 2. When the second variable lens VL2 is activated and the first variable lens VL1 is deactivated, the lens array set 500 may serve as the lens LS shown in FIG. 4. When both the first variable lens VL1 and the second variable lens VL2 are deactivated, the lens array set 500 may serve as a display device which displays a planar image (e.g., a 2D image).

Curvatures of the first variable lens VL1 and the second variable lens VL2 may be controlled. For example, referring to FIG. 2, a focal distance of the lens LS at a first viewpoint may be adjusted according to the curvature of the first variable lens VL1. Accordingly, a distance at which the user of the display device 100 (see FIG. 1) can perceive the 3D effect of an image having the first viewpoint can be adjusted. For example, referring to FIG. 4, a focal distance of the lens LS at the second viewpoint may be adjusted according to the curvature of the second variable lens VL2. Accordingly, a distance at which the user of the display device 100 (see FIG. 1) can perceive the 3D effect of an image having the second viewpoint can be adjusted. Hereinafter, for convenience of description, a case where the curvature of each of the activated first variable lens VL1 and the activated second variable lens VL2 have a predetermined value is described as an example, but embodiments of the present disclosure are not limited thereto. For example, the curvature of the activated first variable lens VL1 may be equal to the curvature of the activated second variable lens VL2, but embodiments of the present disclosure are not limited thereto.

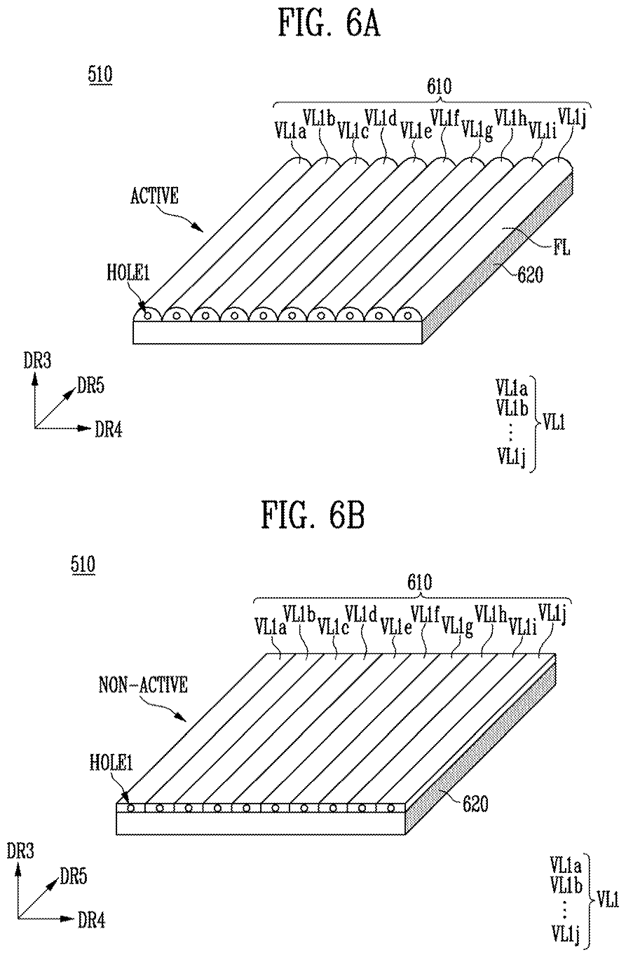

FIG. 6A and FIG. 6B are views illustrating the first lens array 510 shown in FIG. 5.

In FIG. 6A, the first lens array 510 is illustrated as being activated (or in an active state ACTIVE), and in FIG. 6B, the first lens array 510 is illustrated as being deactivated (or in a non-active state NON_ACTIVE).

The first lens array 510 may include a first variable lens array 610 and a first support plane 620.

The first variable lens array 610 may include a plurality of first variable lenses VL1a, VL1b, . . . , and VL1j (hereinafter, referred to as VL1a to VL1j). Although an embodiment in which the first variable lens array 610 includes ten first variable lenses VL1a to VL1j is exemplarily illustrated in FIG. 6A and FIG. 6B, embodiments of the present disclosure are not limited thereto. In some embodiments, the first variable lens array 610 may include 10 or fewer first variable lenses, or may include more than 10 first variable lenses. Hereinafter, for convenience of description, an embodiment in which the first variable lens array 610 includes ten first variable lenses VL1a to VL1j is described as an example. However, embodiments of the present disclosure are not limited thereto.

Each of the plurality of first variable lenses VL1a to VL1j may extend in the fifth direction DR5. The plurality of first variable lenses VL1a to VL1j may be disposed adjacent to each other in the fourth direction DR4. For example, the first variable lens array 610 may include first variable lenses VL1a to VL1j of first to tenth columns, respectively. For example, the first variable lens VL1a of the first column and the first variable lens VL1b of the second column may be disposed adjacent to each other in the fourth direction DR4. For example, the first variable lens VL1b of the second column and the first variable lens VL1c of the third column may be disposed adjacent to each other in the fourth direction DR4.

Each of the plurality of first variable lenses VL1a to VL1j may include a first hole HOLE1. Referring to FIG. 6A and FIG. 6B, the first hole HOLE1 may be disposed at a side end (e.g., an end of a side in the fifth direction DR5) of each of the plurality of first variable lenses VL1a to VL1j.

The first hole HOLE1 may be configured to inject a fluid FL into the first variable lens array 610 or to discharge the fluid FL injected into the first variable lens array 610. When the fluid FL is injected into the first variable lens array 610 through the first hole HOLE1, the first lens array 510 may be in the active state ACTIVE. When the fluid FL is discharged from the first variable lens array 610 through the first hole HOLE1, the first lens array 510 may be in the non-active state NON-ACTIVE.

The fluid FL may include a gas, a liquid, or another material that flows or deforms under applied shear stress. The fluid FL may have a refractive index in a predetermined range. The fluid FL may include, for example, a light transmissive polymer having a refractive index between about 1.5 and about 1.7, but embodiments of the present disclosure are not limited thereto. By the fluid FL, light incident onto the first lens array 510 may be refracted, and the refracted light may be emitted from the first lens array 510. Accordingly, the first lens array 510 in the active state ACTIVE can serve as a lens.

The first variable lens array 610 may include an elastic body having light transmissivity. For example, the first variable lens array 610 may include a plastic film. The plastic film may include, for example, a High Density Polyethylene (HDPE) film, a Low Density Polyethylene (LDPE) film, a polypropylene (PP) film, polyvinyl alcohol (PVA) film, a Cast Polypropylene (CPP) film, a Biaxially Oriented Polypropylene (BOPP) film, a Polyethylene terephthalate (PET) film, a Polyamide (PA) film, a Polyvinyl Chloride (PVC) film, a Polystyrene (PS) film, and/or the like. However, embodiments of the present disclosure are not limited, and any one of various materials having elasticity while having light transmissivity may be selected according to the choice of those skilled in the art.

The first variable lens array 610 may be expanded when the fluid FL is injected into the first variable lenses VL1a to VL1j, and be contracted when the fluid FL is discharged therefrom. For example, referring to FIG. 6A, the first variable lens array 610 may be expanded (e.g., expanded in the third direction DR3) as the fluid FL is injected into first variable lenses VL1a to VL1j. For example, referring to FIG. 6B, the first variable lens array 610 may be contracted as the fluid FL is discharged therefrom. A top surface of the contracted first variable lens array 610 may be parallel (or substantially parallel) to a plane defined by the fourth direction DR4 and the fifth direction DR5. For example, he top surface of the contracted first variable lens array 610 may be substantially flat.

The first support plane 620 may be configured to support the first variable lens array 610. The first support plane 620 may include a rigid material having light transmissivity. For example, the first support plane 620 may include glass, light transmissive plastic, and/or the like, but embodiments of the present disclosure are not limited to the above-describe example.

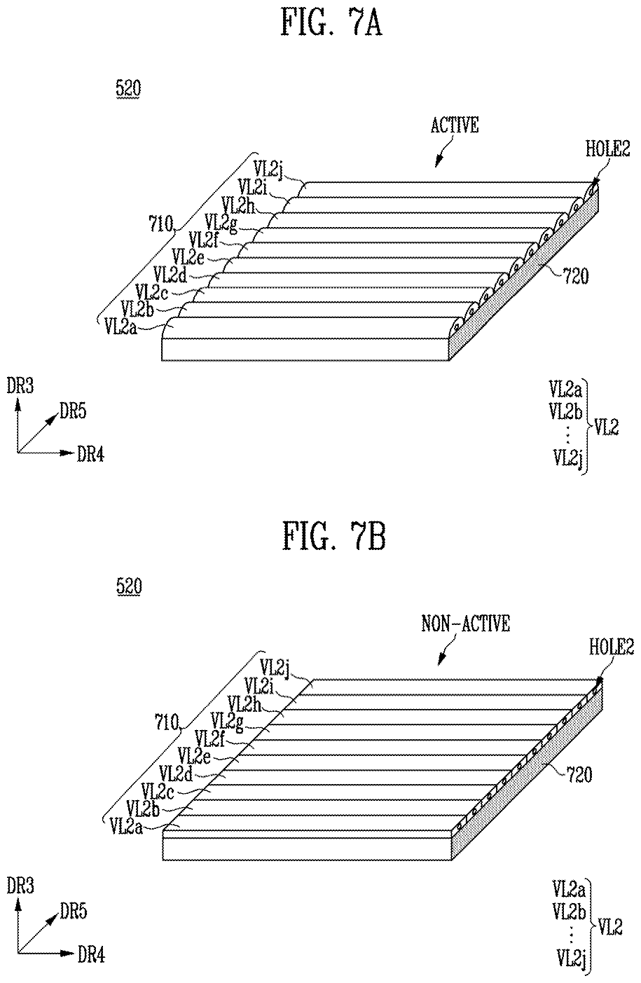

FIG. 7A and FIG. 7B are views illustrating the second lens array 520 shown in FIG. 5.

Referring to FIG. 7A, the second lens array 520, which is activated (or in the active state ACTIVE), is illustrated, and referring to FIG. 7B, the second lens array 520, which is deactivated (or in the non-active state NON_ACTIVE), is illustrated.

The second lens array 520 may include a second variable lens array 710 and a second support plane 720.

The second variable lens array 710 may include a plurality of second variable lenses VL2a, VL2b, . . . , and VL2j (hereinafter, referred to as VL2a to VL2j). Although an embodiment in which the second variable lens array 710 includes ten second variable lenses VL2a to VL2j is exemplarily illustrated in FIG. 7A and FIG. 7B, embodiments of the present disclosure are not limited thereto. In some embodiments, the second variable lens array 710 may include 10 or fewer second variable lenses, or may include more than 10 second variable lenses. Hereinafter, for convenience of description, an embodiment in which the second variable lens array 710 includes ten second variable lenses VL2a to VL2j is described as an example. However, embodiments of the present disclosure are not limited thereto.

Each of the plurality of second variable lenses VL2a to VL2j may extend in the fourth direction DR4. The plurality of second variable lenses VL2a to VL2j may be disposed adjacent to each other in the fifth direction DR5. For example, the second variable lens array 710 may include second variable lenses VL2a to VL2j of first to tenth rows, respectively. The second variable lens VL2a of the first row and the second variable lens VL2b of the second row may be disposed adjacent to each other in the fifth direction DR5. The second variable lens VL2b of the second row and the second variable lens VL1c of the third row may be disposed adjacent to each other in the fifth direction DR5.

Each of the plurality of second variable lenses VL2a to VL2j may include a second hole HOLE2. Referring to FIG. 7A and FIG. 7B, the second hole HOLE2 may be disposed at a side end (e.g., an end of a side in the fourth direction DR4) of each of the plurality of second variable lenses VL2a to VL2j.

The second hole HOLE2 may be configured to inject a fluid FL into the second variable lens array 710 or to discharge the fluid FL injected into the second variable lens array 710. When the fluid FL is injected into the second variable lens array 710 through the second hole HOLE2, the second lens array 520 may be in the active state ACTIVE. When the fluid FL is discharged from the second variable lens array 710 through the second hole HOLE2, the second lens array 520 may be in the non-active state NON-ACTIVE.

The fluid FL may include a gas, a liquid, or another material that flows or deforms under applied shear stress. The fluid FL may have a refractive index in a predetermined range. The fluid FL may include, for example, a light transmissive polymer having a refractive index between about 1.5 and about 1.7, but embodiments of the present disclosure are not limited thereto. By the fluid FL, light incident onto the second lens array 520 may be refracted, and the refracted light may be emitted from the second lens array 520. Accordingly, the second lens array 520 in the active state ACTIVE can serve as a lens.

The fluid FL injected into the second lens array 520 may correspond to the fluid FL discharged from the first lens array 510 (see FIG. 6A and FIG. 6B). The fluid FL injected into the first lens array 510 may correspond to the fluid FL discharged from the second lens array 520.

The second variable lens array 710 may include an elastic body having light transmissivity. For example, the second variable lens array 710 may include a plastic film. The plastic film may include, for example, a High Density Polyethylene (HDPE) film, a Low Density Polyethylene (LDPE) film, a polypropylene (PP) film, polyvinyl alcohol (PVA) film, a Cast Polypropylene (CPP) film, a Biaxially Oriented Polypropylene (BOPP) film, a Polyethylene terephthalate (PET) film, a Polyamide (PA) film, a Polyvinyl Chloride (PVC) film, a Polystyrene (PS) film, and/or the like. However, embodiments of the present disclosure are not limited, and any one of various materials having elasticity while having light transmissivity may be selected according to the choice of those skilled in the art.

The second variable lens array 710 may be expanded when the fluid FL is injected into the plurality of second variable lenses VL2a to VL2j, and be contracted when the fluid FL is discharged from the plurality of second variable lenses VL2a to VL2. For example, referring to FIG. 7A, the second variable lens array 710 may be expanded in the third direction DR3 as the fluid FL is injected into the plurality of second variable lenses VL2a to VL2. For example, referring to FIG. 7B, the second variable lens array 710 may be contracted as the fluid FL is discharged from the plurality of second variable lenses VL2a to VL2. A top surface of the contracted second variable lens array 710 may be parallel (or substantially parallel) to a plane defined by the fourth direction DR4 and the fifth direction DR5. For example, the top surface of the contracted second variable lens array 710 may be substantially flat.

The second support plane 720 may be configured to support the second variable lens array 710. The second support plane 720 may include a rigid material having light transmissivity. For example, the second support plane 720 may include glass, light transmissive plastic, and/or the like, but embodiments of the present disclosure are not limited to examples described herein.

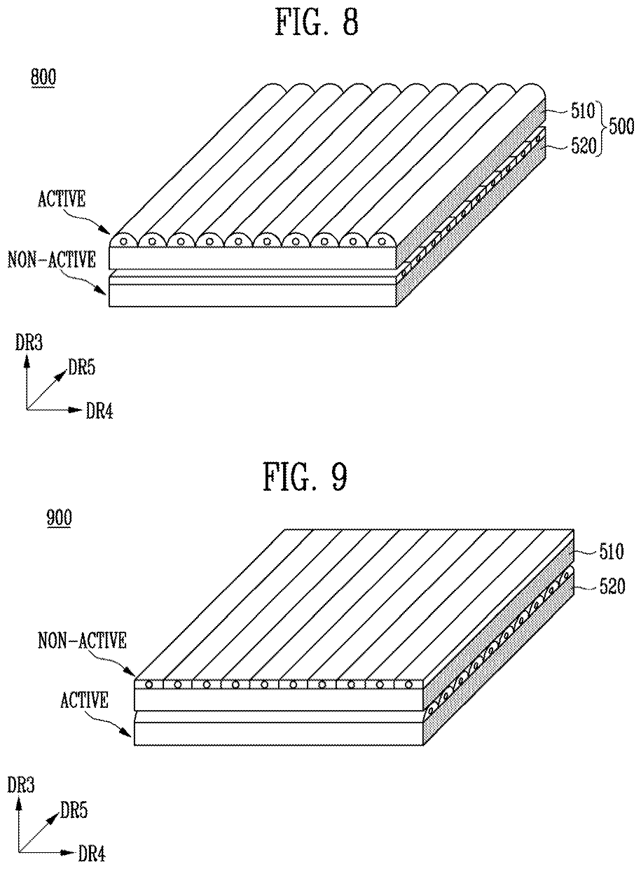

FIG. 8 is an embodiment of a first viewing angle lens array set 800 using the lens array set 500 shown in FIG. 5.

Referring to FIG. 8, the first viewing angle lens array set 800 may be used to display a 3D image at a first viewpoint. For example, the first viewing angle lens array set 800 may serve as the plurality of lenses LS described through FIG. 2.

In the first viewing angle lens array set 800, the first lens array 510 may be in the active state ACTIVE, and the second lens array 520 may be in the non-active state NON-ACTIVE.

In some embodiments, in the first viewing angle lens array set 800, a focal distance of the first viewing angle lens array set 800 may be controlled according to an amount of the fluid FL (see FIG. 6A and FIG. 6B) injected into the first lens array 510.

FIG. 9 is an embodiment of a second viewing angle lens array set 900 using the lens array set 500 shown in FIG. 5.

Referring to FIG. 9, the second viewing angle lens array set 900 may be used to display a 3D image at a second viewpoint. For example, the second viewing angle lens array set 900 may serve as the plurality of lenses LS described in FIG. 5.

In the second viewing angle lens array set 900, the first lens array 510 may be in the non-active state NON-ACTIVE, and the second lens array 520 may be in the active state ACTIVE.

In some embodiments, in the second viewing angle lens array set 900, a focal distance of the second viewing angle lens array set 900 may be controlled according to an amount of the fluid FL (see FIG. 7A and FIG. 7B) injected into the second lens array 520.

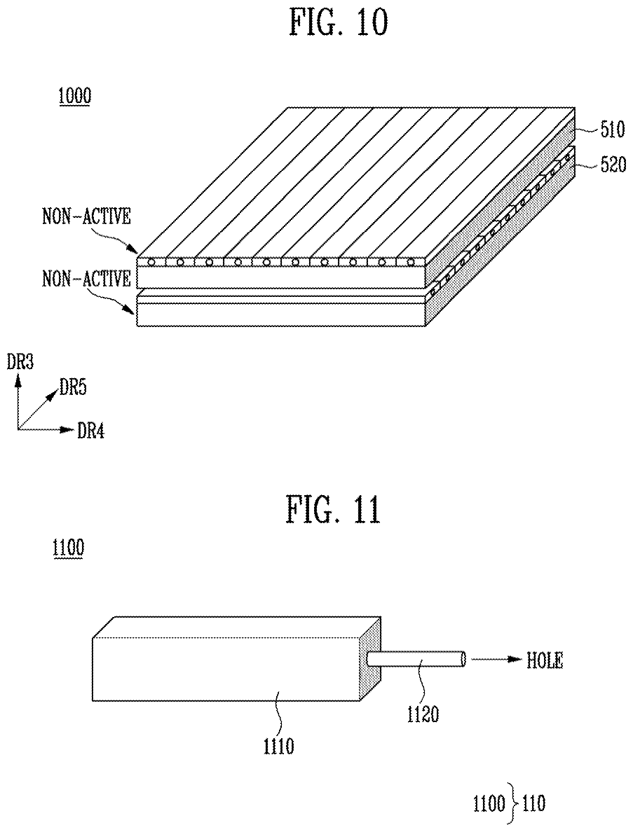

FIG. 10 is an embodiment of a wide viewing angle lens array set 1000 using the lens array set 500 shown in FIG. 5.

Referring to FIG. 10, the wide viewing angle lens array set 1000 may be used to display a planar image (2D image) at a wide viewing angle. For example, the wide viewing angle lens array set 1000 may be used to provide a planar image at a wide viewpoint including the first viewpoint and the second viewpoint.

In the wide viewing angle lens array set 1000, the first lens array 510 may be in the non-active state NON-ACTIVE, and the second lens array 520 may be in the non-active state NON-ACTIVE.

The wide viewing angle lens array set 1000 may reduce the refraction of incident light, and a planar image may be displayed in a relatively wide range. For example, the wide viewing angle lens array set 1000 may minimize the refraction of incident light.

Referring to FIG. 8, FIG. 9, and FIG. 10 described herein, the lens array set 500 in accordance with embodiments of the present disclosure may be used to provide a 3D image at two or more viewpoints and a planar image at a wide viewpoint.

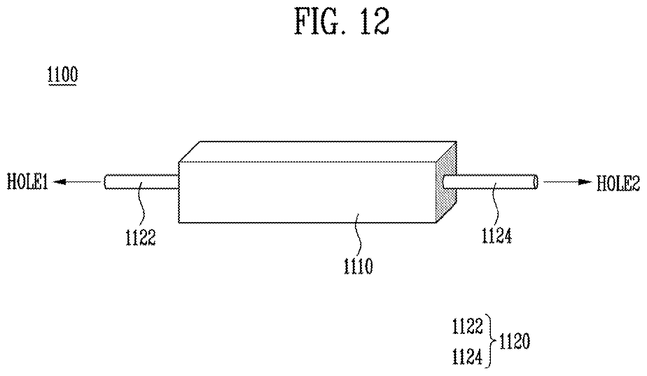

FIG. 11 is an example of a fluid storage part 1100 in accordance with embodiments of the present disclosure. FIG. 12 is a view illustrating the fluid storage part 1100 shown in FIG. 11 in accordance with embodiments of the present disclosure.

The fluid storage part 1100 may be configured to store the fluid FL (see FIGS. 6A and 7A) discharged from the lens array set 500 (see FIG. 5). The fluid storage part 1100 may be included in the lens panel 110.

The fluid storage part 1100 may include a storage tank 1110. The storage tank 1110 may be configured to store a fluid and a tube 1120 configured to connect between the storage tank 1110 and a hole HOLE.

The storage tank 1110 may be configured to store the fluid FL (see FIG. 6A and FIG. 7A). The fluid FL may be stored in a liquid state or a gaseous state. Referring to FIG. 11, the storage tank 1110 may have a rectangular parallelepiped shape. However, embodiments of the present disclosure are not limited thereto. For example, the storage tank 1110 may have a shape such as a polyhedron shape or a spherical shape, in addition to the rectangular parallelepiped shape. The shape of the storage tank 1110 may be fixed. However, in some embodiments, the storage tank 1110 may have an atypical shape. For example, the storage tank 1110 may include an elastic body formed of a plastic material or a rubber material. The storage tank 1110 may be expanded by a fluid stored therein.

The tube 1120 may connect between the storage tank 1110 and the hole HOLE. The hole HOLE may correspond to a first hole HOLE1, a second hole HOLE2, or the like. The tube 1120 may be configured with, for example, a flexible material or a rigid material.

Referring to FIG. 12, the tube 1120 may include a first tube 1122 and a second tube 1124. The first tube 1122 may connect between the storage tank 1110 and the first hole HOLE1. The second tube 1124 may connect between the storage tank 1110 and the second hole HOLE2.

The first tube 1122 may be configured to transfer a fluid discharged from the first hole HOLE to the storage tank 1110 or to transfer a fluid discharged from the storage tank 1110 to the first hole HOLE1. For example, the fluid may be transferred between the first lens array 510 and the storage tank 1110 through the first hole HOLE1 and the first tube 1122.

The second tube 1124 may be configured to transfer a fluid discharged from the second hole HOLE2 to the storage tank 1110 or to transfer a fluid discharged from the storage tank 1110 to the second hole HOLE2. For example, the fluid may be transferred between the second lens array 520 and the storage tank 1110 through the second hole HOLE2 and the second tube 1124.

By the fluid storage part 1100 in accordance with embodiments of the present disclosure, the fluid discharged from the first hole HOLE1 may be injected into the second hole HOLE2 via the fluid storage part 1100, and the fluid discharged from the second hole HOLE2 may be injected into the first hole HOLE1 via the fluid storage part 1100. Accordingly, the volume of fluid in the lens panel 110 (see FIG. 1) can be reduced when the fluid storage part 1100 is connected to the first hole HOLE1 and the second hole HOLE2. For example, in a case that the first lens array 510 and the second lens array 520 are both connected to the fluid storage part 1100, the lens panel 110 may be lightened and/or made smaller than a case with separate storage parts for each lens array.

FIG. 13 is an example of a pressurizing device 1300 in accordance with embodiments of the present disclosure.

Referring to FIG. 13, the lens panel 110 in accordance with embodiments of the present disclosure may include a pressurizing device 1300. The pressurizing device 1300 may be configured to pressurize a lens array LA. The lens array LA may correspond to any one of the first lens array 510 (see FIG. 5) and the second lens array 520 (see FIG. 5).

The pressurizing device 1300 in accordance with embodiments of the present disclosure may include a pressurizing member 1310, an elastic body 1320, a motor 1330, a connection member 1340, a fixing pin 1350, and/or the like.

The pressurizing member 1310 may be configured to apply pressure to the lens array LA. The pressurizing member 1310 may be configured to apply pressure to the lens array LA at a top surface and a back surface of the lens array LA. The pressurizing member 1310 may include a first pressurizing member 1310a and a second pressurizing member 1310b. The first pressurizing member 1310a may be in contact with a surface (e.g., the top surface) of the lens array LA. The second pressurizing member 1310b may be in contact with another surface (e.g., the back surface) of the lens array LA.

The pressurizing member 1310 may press the first pressurizing member 1310a and the second pressurizing member 1310b together. When the pressurizing member 1310 presses the lens array LA (e.g., when the first pressurizing member 1310a and the second pressurizing member 1310b become close to each other), the internal pressure of the lens array LA may increase, and a fluid may be discharged from the inside of the lens array LA through a hole HOLE.

The pressurizing member 1310 may pull the first pressurizing member 1310a and the second pressurizing member 1310b away from one another. When the pressurizing member 1310 pulls at the lens array LA (e.g., when the first pressurizing member 1310a and the second pressurizing member 1310b become distant from each other), the internal pressure of the lens array LA may decrease, and a fluid may be injected into the lens array LA through the hole HOLE. The fluid discharged through the hole HOLE may be stored in the fluid storage part 1100 (see FIG. 11).

The elastic body 1320 may be configured to provide an elastic force. The elastic body 1320 may include, for example, a spring and/or the like. When the elastic body 1320 is compressed by an external force, the elastic body 1320 may provide the elastic force in a direction in which the elastic body 1320 is relaxed. When the elastic body 1320 is stretched by an external force, the elastic body 1320 may provide the elastic force in a direction in which the elastic body 1320 is compressed. For example, the elastic body 1320 may apply a force when compressed or stretched in a direction in which the elastic body 1320 is an uncompressed and un-stretched state.

The motor 1330 may be configured to contract or relax the elastic body 1320. The motor 1330 may provide kinetic energy through rotation. The kinetic energy provided from the motor 1330 may be used to contract or relax the elastic body 1320. An operation of the motor 1330 may be controlled by a control device (not shown) configured to control an operation of the display device 100 (see FIG. 1) in accordance with embodiments of the present disclosure. The control device may include, for example, an Application Processor (AP), a host system, and/or the like, but embodiments of the present disclosure are not limited thereto. For example, the Application Processor may receive inclination information of the display device 100 in accordance with embodiments of the present disclosure from a gyroscope or the like, and control an operation of the motor 1330 according to the received inclination information. Accordingly, the operation of the motor 1330 can be adaptively controlled to adjust an angle of the display device 100. For example, the motor 1330 may adaptively control an angle of the display device 100 relative to a view of the user. However, embodiments of the present disclosure are not limited thereto. For example, the AP may receive an input (e.g., an input for controlling a rotation time or the like of the motor 1330) from the user, and control the operation of the motor 1330, based on the input of the user.

The connection member 1340 may be configured to connect between the elastic body 1320 and the pressurizing member 1310. The connection member 1340 may transfer the elastic force provided from the elastic body 1320 to the pressurizing member 1310. For example, the elastic body 1320 is contracted, the first pressurizing member 1310a and the second pressurizing member 1310b may become close to each other by the connection member 1340 connected to the elastic body 1320. For example, when the elastic body 1320 is relaxed, the first pressurizing member 1310a and the second pressurizing member 1310b may become distant from each other by the connection member 1340 connected to the elastic body 1320.

The fixing pin 1350 may be configured to selectively fix a position of the elastic body 1320. By the fixing pin 1350, the elastic body 1320 may be fixed in a contracted state or a relaxed state.

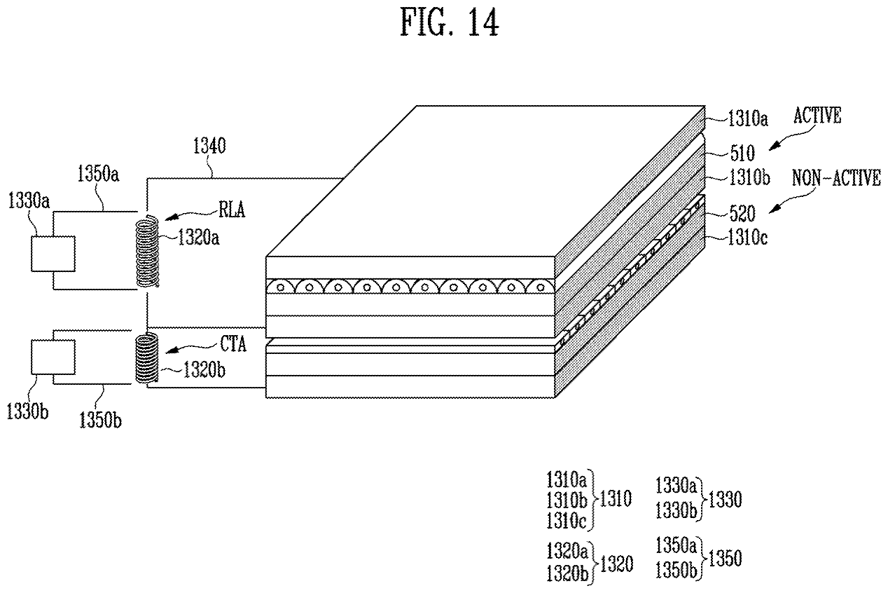

FIG. 14 is a view illustrating the pressurizing device 1300 shown in FIG. 13 in accordance with embodiments of the present disclosure.

Referring to FIG. 14, the pressurizing device 1300 may be configured to provide pressure to the first lens array 510 and the second lens array 520. The pressurizing device 1300 may include a pressurizing member 1310, an elastic body 1320, a motor 1330, a connection member 1340, a fixing pin 1350, and/or the like.

The pressurizing member 1310 may include a first pressurizing member 1310a, a second pressurizing member 1310b, a third pressurizing member 1310c, and/or the like. The first pressurizing member 1310a may be in contact with a top surface of the first lens array 510. The second pressurizing member 1310b may be in contact with a back surface of the first lens array 510. The second pressurizing member 1310b may be in contact with a top surface of the second lens array 520. The third pressurizing member 1310c may be in contact with a back surface of the second lens array 520.

Referring to FIG. 14, a state in which the first pressurizing member 1310a and the second pressurizing member 1310b are distant from each other and a state in which the second pressurizing member 1310b and the third pressurizing member 1310c are close to each other are illustrated. In an embodiment, the first lens array 510 may be in the active state ACTIVE, and the second lens array 520 may be in the non-active state NON-ACTIVE. Accordingly, the lens array set 500 (see FIG. 5) may serve as the first viewing angle lens array set 800 (see FIG. 8) for providing a 3D image at a first viewpoint.

In some embodiments, the first pressurizing member 1310a and the second pressurizing member 1310b may be in a state in which the first pressurizing member 1310a and the second pressurizing member 1310b are close to each other, and the second pressurizing member 1310b and the third pressurizing member 1310c may be in a state in which the second pressurizing member 1310b and the third pressurizing member 1310c are distant from each other. For example, the first lens array 510 may be in the non-active state NON-ACTIVE, and the second lens array 520 may be in the active state ACTIVE. Accordingly, the lens array set 500 (see FIG. 5) may serve as the second viewing angle lens array set 900 (see FIG. 9) for providing a 3D image at the second viewpoint.

In some embodiments, the first pressurizing member 1310a and the second pressurizing member 1310b are in a state in which the first pressurizing member 1310a and the second pressurizing member 1310b are close to each other, and the second pressurizing member 1310b and the third pressurizing member 1310c may be in a state in which the second pressurizing member 1310b and the third pressurizing member 1310c are close to each other. For example, the first lens array 510 may be in the non-active state NON-ACTIVE, and the second lens array 520 may be in the non-active state NON-ACTIVE. Accordingly, the lens array set 500 (see FIG. 5) may serve as the wide viewing angle lens array set 1000 (see FIG. 10) for providing a planar image at a wide viewing angle.

The elastic body 1320 may include a first elastic body 1320a and a second elastic body 1320b. The first elastic body 1320a may be configured to provide an elastic force to the first pressurizing member 1310a and the second pressurizing member 1310b. The second elastic body 1320b may be configured to provide an elastic force to the second pressurizing member 1310b and the third pressurizing member 1310c. The first elastic body 1320a and the second elastic body 1320b may have a same elastic modulus. In some embodiments, the first elastic body 1320a and the second elastic body 1320b may have different elastic moduli. However, embodiments of the present disclosure are not limited. In some embodiments, the first elastic body 1320a and the second elastic body 1320b may be connected to each other by the connection member 1340. However, embodiments of the present disclosure are not limited thereto. The first elastic body 1320a and the second elastic body 1320b may not be connected to each other. For example, a connection between the first elastic body 1320a and the second elastic body 1320b may be interrupted or omitted.

Referring to FIG. 14, an embodiment in which the first elastic body 1320a is in a relaxed state RLA and the second elastic body 1320b is in a contracted state CTA is illustrated. The first elastic body 1320a in the relaxed state RLA may correspond to the first lens array 510 in the active state ACTIVE. The second elastic body 1320b in the contracted state CTA may correspond to the second lens array 520 in the non-active state NON-ACTIVE.

The motor 1330 may include a first motor 1330a and a second motor 1330b. The first motor 1330a may be configured to contract or relax the first elastic body 1320a. The second motor 1330b may be configured to contract or relax the second elastic body 1320b.

The connection member 1340 may connect between the first elastic body 1320a and the first pressurizing member 1310a. The connection member 1340 may connect between the first elastic body 1320a and the second pressurizing member 1310b. The connection member 1340 may connect between the second elastic body 1320b and the second pressurizing member 1310b. The connection member 1340 may connect between the second elastic body 1320b and the third pressurizing member 1310c.

The fixing pin 1350 may include a first fixing pin 1350a and a second fixing pin 1350b. The first fixing pin 1350a may be configured to selectively fix a position of the contracted or relaxed first elastic body 1320a. The second fixing pin 1350b may be configured to selectively fix a position of the contracted or relaxed second elastic body 1320b.

Further referring to FIG. 1, the pressurizing member 1310 may overlap (e.g., overlapping in the third direction DR3) the display area DA of the display panel 120.

The elastic body 1320 may be located at the periphery of the display area DA of the display panel 120 (e.g., overlapped with the non-display area NA in the third direction DR3), or be located in an area between the display panel 120 and the back cover 130.

The motor 1330 may be located at the periphery of the display area DA of the display panel 120 (e.g., overlapped with the non-display area NA in the third direction DR3), or be located in an area between the display panel 120 and the back cover 130.

The connection member 1340 may be located at the periphery of the display area DA of the display panel 120 (e.g., overlapped with the non-display area NA in the third direction DR3), or be located in an area between the display panel 120 and the back cover 130. The fixing pin 1350 may be located at the periphery of the display area DA of the display panel 120 (e.g., overlapped with the non-display area NA in the third direction DR3), or be located in an area between the display panel 120 and the back cover 130.

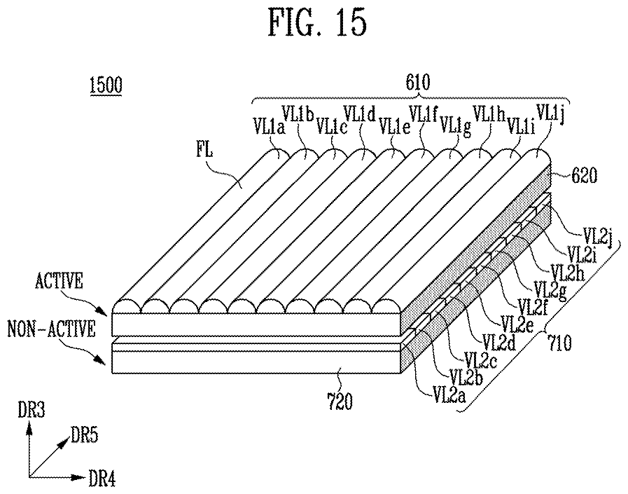

FIG. 15 is an embodiment of a first viewing angle lens array set 1500 using the lens array set 500 shown in FIG. 5.

Referring to FIG. 15, an embodiment in which a hole (not shown) is located inside the lens array set 500 (see FIG. 5) is illustrated. For example, the hole may not be exposed at a side of the lens array set 500. In an embodiment, a fluid FL may directly move between a first variable lens array 610 and a second variable lens array 710. For example, when pressure is applied to the first variable lens array 610, the fluid FL may be discharged from the inside of the first variable lens array 610, and the discharged fluid FL may be directly injected into the second variable lens array 710. For example, when pressure is applied to the second variable lens array 710, the fluid FL may be discharged from the inside of the second variable lens array 710, and the discharged fluid FL may be directly injected into the first variable lens array 610. Pressure may be selectively applied to the first variable lens array 610 and the second variable lens array 710 by the pressurizing device 1300 (see FIG. 13).

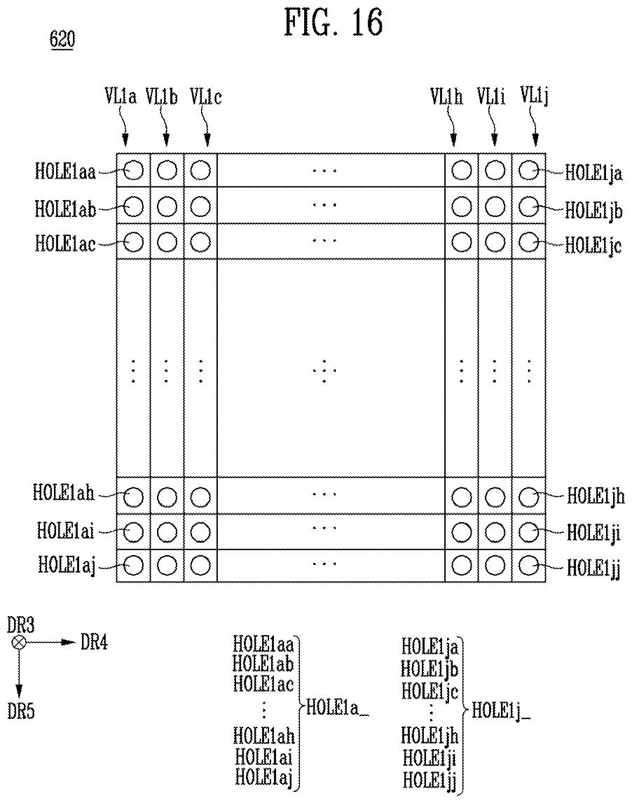

FIG. 16 is an embodiment in which a plurality of first holes HOLE1 are disposed at the back surface of the first lens array 510 shown in FIG. 5.

Referring to FIG. 16, a plurality of first holes HOLE1 are illustrated. The plurality of first holes HOLE1 may be disposed in a matrix. In an example, the plurality of first holes HOLE1 may be disposed in a square matrix in which a number of rows and a number of columns are the same. Hereinafter, for convenience of description, an embodiment in which the plurality of first holes HOLE1 are disposed in the square matrix is described as an example. However, embodiments of the present disclosure are not limited thereto.

The plurality of first holes HOLE1 may be designated as first holes HOLE1xy of an xth (where x is an integer between 1 and 10) column and a yth (where y is an integer between 1 and 10) row according to positions thereof. For example, first holes HOLEla_of a first column may include a first hole HOLElaa of the first column and a first row, a first hole HOLElab of the first column and a second row, a first hole HOLElaj of the first column and a tenth row, and the like. For example, first holes HOLElj_of a tenth column may include a first hole HOLElja of the tenth column and the first row, a first hole HOLE1jb of the tenth column and the second row, a first hole HOLIjj of the tenth column and the tenth row, and the like.

The first holes HOLEla_of the first column may be disposed corresponding to a first variable lens VL1a of the first column. First holes HOLE1b_of a second column may be disposed corresponding to a first variable lens VL1b of the second column. Similarly, the first holes HOLElj_of the tenth column may be disposed corresponding to a first variable lens VL1j of the tenth column.

The plurality of first holes HOLE1 may be disposed at the back surface of the first lens array 510 (see FIG. 5), and be formed in the first support plane 620. The plurality of first holes HOLE1 may extend (e.g., to extend in the third direction DR3) from the first support plane 620 to the first variable lens array 610 (see FIG. 15).

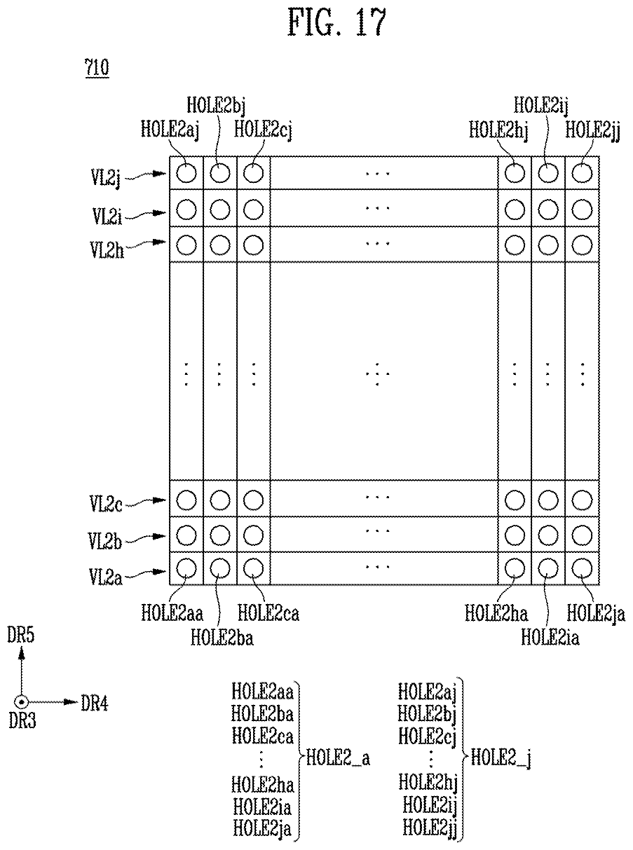

FIG. 17 is an embodiment in which a plurality of second holes HOLE2 corresponding to the plurality of first holes HOLE1 shown in FIG. 16 are disposed at a top surface of the second lens array 520 shown in FIG. 5.

Referring to FIG. 17, a plurality of second holes HOLE2 are illustrated. The plurality of second holes HOLE2 may be disposed in a matrix. In an example, the plurality of second holes HOLE2 may be disposed in a square matrix in which a number of rows and a number of columns are the same. Hereinafter, for convenience of description, an embodiment in which the plurality of second holes HOLE2 are disposed in the square matrix is described as an example. However, embodiments of the present disclosure are not limited thereto.

The plurality of second holes HOLE2 may be designated as second holes HOLE2xy of an xth (where x is an integer between 1 and 10) column and a yth (where y is an integer between 1 and 10) row according to positions thereof. For example, second holes HOLE2_a of a first row may include a second hole HOLE2aa of a first column and the first row, a second hole HOLE2ba of a second column and the first row, a second hole HOLE2ja of a tenth column and the first row, and the like. For example, second holes HOLE2_j of a tenth row may include a second hole HOLE2aj of the first column and the tenth row, a second hole HOLE2bj of the second column and the tenth row, a second hole HOL2jj of the tenth column and the tenth row, and the like.

The second holes HOLE2_a of the first row may be disposed corresponding to a second variable lens VL2a of the first row. Second holes HOLE2_b of a second row may be disposed corresponding to a second variable lens VL2b of the second row. Similarly, the second holes HOLE2_j of the tenth row may be disposed corresponding to a second variable lens VL2j of the tenth row.

The plurality of second holes HOLE2 may be disposed at the top surface of the second lens array 520 (see FIG. 5), and be disposed in the second variable lens array 710.

Referring to FIG. 17 together with FIG. 16 described above, a first hole HOLE1xy of the xth column and the yth row may be located corresponding to a second hole HOLE2xy of the xth column and the yth row. For example, the first hole and the second hole may be connected for facilitating transfer of the fluid therebetween, and for facilitating transfer of the fluid between the first variable lens array 610 and the second variable lens array 710. Accordingly, a fluid discharged through the first hole HOLE1xy of the xth column and the yth row may be injected into the second hole HOLE2xy of the xth column and the yth row. Similarly, a fluid discharged through the second hole HOLE2xy of the xth column and the yth row may be injected into the first hole HOLE1xy of the xth column and the yth row. Accordingly, the first viewing angle lens array set 800 (see FIG. 8) or the second viewing angle lens array set 900 (see FIG. 9) can be implemented.

Referring to FIG. 17 together with FIG. 16 described above, a number of the plurality of first holes HOLE1 may be equal to a value (e.g., 100) obtained by multiplying a number (e.g., 10) of the plurality of first variable lenses VL1a to VL1j and a number (e.g., 10) of the plurality of second variable lenses VL2a to VL2j. In addition, a number of the second holes HOLE2 may be equal to a value obtained by multiplying a number of the plurality of first variable lenses VL1a to VL1j and a number of the plurality of second variable lenses VL2a to VL2j.

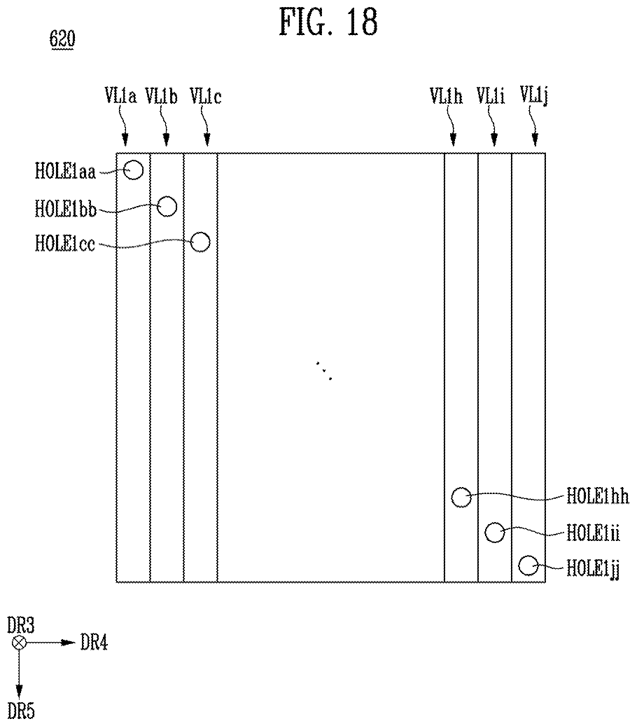

FIG. 18 is an embodiment in which a plurality of first holes are disposed at the back surface of the first lens array 510 shown in FIG. 5.

Referring to FIG. 18, a plurality of first holes HOLE1 are illustrated. The plurality of first holes HOLE1 may be provided respectively corresponding to a plurality of first variable lenses VL1a to VL1j. For example, the plurality of first holes HOLE1 may be disposed aligned in a diagonal direction to respectively correspond to the plurality of first variable lenses VL1a to VL1j.

The plurality of first holes HOLE1 may be designated as first holes HOLE1xy of an xth (where x is an integer between 1 and 10) and a yth (where y is an integer between 1 and 10) according to positions thereof. For example, the plurality of first holes HOLE1 may be designated as a first hole HOLElaa of a first column and a first row, a first hole HOLE1bb of a second column and a second row, a first hole HOLEljj of a tenth column and a tenth row, and the like.

A first hole of the first column (e.g., the first hole HOLElaa of the first column and the first row) may be disposed corresponding to a first variable lens VL1a of the first column. A first hole of the second column (e.g., the first hole HOLE1bb of the second column and the second row) may be disposed corresponding to a first variable lens VL1b of the second column. A first hole of the tenth column (e.g., the first hole HOLEljj of the tenth column and the tenth row) may be disposed corresponding to a first variable lens VL1j of the tenth column.

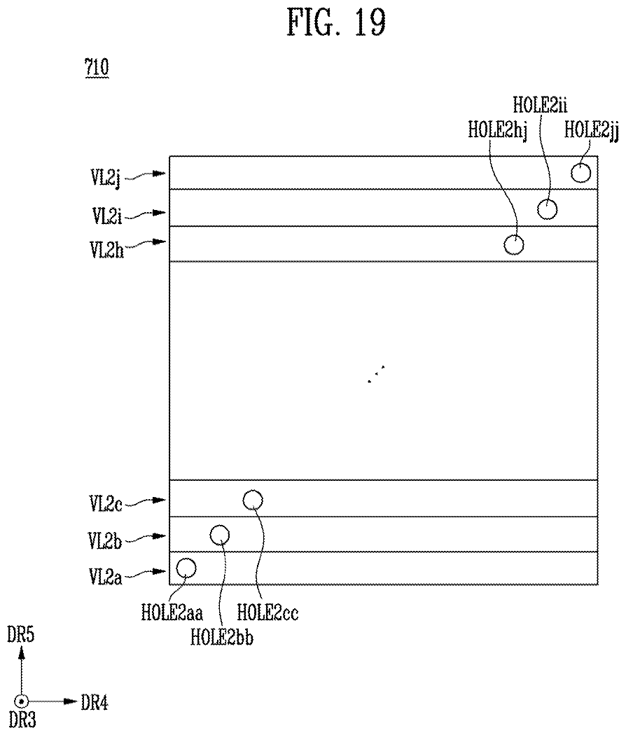

FIG. 19 is an embodiment in which a plurality of second holes corresponding to the plurality of first holes shown in FIG. 18 are disposed at the top surface of the second lens array 520 shown in FIG. 5.

Referring to FIG. 19, a plurality of second holes HOLE2 are illustrated. The plurality of second holes HOLE2 may be disposed corresponding to a plurality of second variable lenses VL2a to VL2j, respectively. For example, the plurality of second holes HOLE2 may be disposed aligned in a diagonal direction to respectively correspond to the plurality of second variable lenses VL2a to VL2j.

The plurality of second holes HOLE2 may be designated as second holes HOLE2xy of an xth (where x is an integer between 1 and 10) and a yth (where y is an integer between 1 and 10) according to positions thereof. For example, the plurality of second holes HOLE2 may be designated as a second hole HOLE2aa of a first column and a first row, a second hole HOLE2bb of a second column and a second row, a second hole HOLE2jj of a tenth column and a tenth row, and the like.

A second hole of the first row (e.g., the second hole HOLE2aa of the first column and the first row) may be disposed corresponding to a second variable lens VL2a of the first row. A second hole of the second row (e.g., the second hole HOLE2bb of the second column and the second row) may be disposed corresponding to a second variable lens VL2b of the second row. A second hole of the tenth row (e.g., the second hole HOLE2jj of the tenth column and the tenth row) may be disposed corresponding to a second variable lens VL2j of the tenth row.

The plurality of second holes HOLE2 may be disposed at the top surface of the second lens array 520 (see FIG. 5), and may be formed in the second variable lens array 710.

Referring to FIG. 19 together with FIG. 18 described herein, a first hole HOLE1xy of the xth column and the yth row may be located corresponding to a second hole HOLE2xy of the xth column and the yth row. Accordingly, a fluid discharged through the first hole HOLE1xy of the xth column and the yth row may be injected into the second hole HOLE2xy of the xth column and the yth row. Similarly, a fluid discharged through the second hole HOLE2xy of the xth column and the yth row may be injected into the first hole HOLE1xy of the xth column and the yth row. Accordingly, the first viewing angle lens array set 800 (see FIG. 8) or the second viewing angle lens array set 900 (see FIG. 9) can be implemented.

Referring to FIG. 19 together with FIG. 18 described herein, a number of the plurality of first holes HOLE1 may be equal to a number (e.g., 10) of the plurality of first variable lenses VL1a to VL1j. In addition, a number of the plurality of second holes HOLE2 may be equal to a number of the plurality of second variable lenses VL2a to VL2j.

In a lens panel and a display device including the same in accordance with the present disclosure, a 3D image may be displayed and perceived by a user at various viewpoints.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with an embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A lens panel comprising:
a first lens array extending in a first direction, the first lens array including a first hole configured to transfer a fluid therethrough; and
a second lens array extending in a second direction different from the first direction, the second lens array including a second hole configured to transfer the fluid therethrough.

2. The lens panel of claim 1, wherein the first hole and the second hole are connected, and the fluid discharged from the first hole of the first lens array is injected into the second hole of the second lens array.

3. The lens panel of claim 1, wherein the first direction is a column direction, and the second direction is a row direction,
wherein the first lens array includes:
a plurality of first variable lenses having a curvature varying as the fluid is injected into or discharged from the plurality of first variable lenses; and
a first support plane configured to support the plurality of first variable lenses, and
wherein the second lens array includes:
a plurality of second variable lenses having a curvature varying as the fluid is injected into or discharged from the plurality of second variable lenses; and
a second support plane configured to support the plurality of second variable lenses.

4. The lens panel of claim 1, wherein the lens panel is configured to display a 3D image at a first viewing angle when the fluid is injected into the first lens array and when the fluid is discharged from the second lens array, and the lens panel is configured to display the 3D image at a second viewing angle when the fluid is discharged from the first lens array and when the fluid is injected into the second lens array.

5. The lens panel of claim 1, wherein the lens panel is configured to display a planar image at a wide viewing angle when the fluid is discharged from the first lens array and the second lens array.

6. The lens panel of claim 1, further comprising a fluid storage part configured to store the fluid,
wherein the fluid storage part includes:
a tube connected to at least one of the first hole or the second hole; and
a storage tank connected to the tube.

7. The lens panel of claim 6, wherein the tube includes:
a first tube connected to the first hole; and
a second tube connected to the second hole,
wherein the storage tank is connected to each of the first tube and the second tube.

8. The lens panel of claim 1, further comprising a pressurizing device configured to pressurize at least one of the first lens array and the second lens array,
wherein the pressurizing device includes:
a pressurizing member on a top surface and a back surface of the at least one of the first lens array and the second lens array;
an elastic body configured to provide an elastic force;
a motor configured to provide power for contracting the elastic body;
a connection member configured to connect between the elastic body and the pressurizing member; and
a fixing pin configured to selectively fix a position of the elastic body which is contracted or relaxed.

9. The lens panel of claim 8, wherein the pressurizing member includes:
a first pressurizing member configured to pressurize the first lens array at a top surface of the first lens array;
a second pressurizing member configured to pressurize the first lens array at a back surface of the first lens array or pressurize the second lens array at a top surface of the second lens array; and
a third pressurizing member configured to pressurize the second lens array at a back surface of the second lens array,
wherein the elastic body includes:
a first elastic body configured to provide an elastic force to the first pressurizing member and the second pressurizing member; and
a second elastic body configured to provide an elastic force to the second pressurizing member and the third pressurizing member, and
wherein the motor includes:
a first motor configured to provide power for contracting the first elastic body; and
a second motor configured to provide power for contracting the second elastic body.

10. The lens panel of claim 1, wherein the first hole is disposed at an end of the first lens array in the first direction, and the second hole is disposed at an end of the second lens array in the second direction.

11. The lens panel of claim 1,
wherein the first lens array includes a plurality of first variable lenses,
wherein the second lens array includes a plurality of second variable lenses, and
wherein the first hole is disposed at a back surface of the first lens array, and the second hole is disposed at a top surface of the second lens array.

12. The lens panel of claim 11, wherein the first lens array includes a plurality of first holes including the first hole, and
the second lens array includes a plurality of second holes including the second hole, and
wherein a number of the plurality of first holes and a number of the plurality of second holes are a same number, and the same number corresponds to a value obtained by multiplying a number of the plurality of first variable lenses and a number of the plurality of second variable lenses.

13. The lens panel of claim 11, wherein the first lens array includes a plurality of first holes including the first hole, and
the second lens array includes a plurality of second holes including the second hole,
wherein each of the plurality of first holes corresponds to any one of the plurality of first variable lenses, and corresponds to any one of the plurality of second variable lenses,
wherein each of the plurality of second holes corresponds to any one of the plurality of first variable lenses, and corresponds to any one of the plurality of second variable lenses, and
wherein the plurality of first holes and the plurality of second holes are disposed aligned in a diagonal direction.

14. The lens panel of claim 1, wherein the fluid includes a polymer having a refractive index between about 1.5 and about 1.7.

15. A display device comprising:
a display panel including a display area in which a plurality of pixels are disposed and a non-display area at a periphery of the display area; and
a lens panel overlapped with the display panel,
wherein the lens panel includes:
a first lens array extending in a first direction, the first lens array including a first hole configured to transfer a fluid therethrough; and
a second lens array extending in a second direction different from the first direction, the second lens array including a second hole configured to transfer the fluid therethrough.

16. The display device of claim 15, wherein the first direction is a column direction, and the second direction is a row direction,
wherein the first lens array includes:
a plurality of first variable lenses overlapped with the display area, the plurality of first variable lenses having a curvature varying as the fluid is injected into or discharged from the plurality of first variable lenses; and
a first support plane configured to support the plurality of first variable lenses, and
wherein the second lens array includes:
a plurality of second variable lenses overlapped with the display area, the plurality of second variable lenses having a curvature varying as the fluid is injected into or discharged from the plurality of second variable lenses; and
a second support plane configured to support the plurality of second variable lenses.

17. The display device of claim 15, further comprising:
a fluid storage part configured to store the fluid,
wherein the fluid storage part includes:
a tube connected to at least one of the first hole or the second hole; and
a storage tank connected to the tube, and
wherein the tube and the storage tank are overlapped with the non-display area; and
a back cover located on a back surface of the display panel, the back cover having the non-display area of the display panel, which is accommodated therein,
wherein the back cover accommodates the fluid storage part.

18. The display device of claim 15, further comprising:
a pressurizing device configured to pressurize at least one of the first lens array and the second lens array,
wherein the pressurizing device includes:
a pressurizing member on a top surface and a back surface of the lens panel;
an elastic body configured to provide an elastic force;
a motor configured to provide power for contracting the elastic body;
a connection member configured to connect between the elastic body and the pressurizing member; and
a fixing pin configured to selectively fix a position of the elastic body that is contracted or relaxed; and
a back cover located on a back surface of the display panel, the back cover having the non-display area of the display panel, which is accommodated therein,
wherein the back cover accommodates the pressurizing device.

19. A lens panel comprising:
a first lens array including a plurality of first variable lenses extending in a first direction and including a first elastic body having light transmissivity; and
a second lens array including a plurality of second variable lenses extending in a second direction and including a second elastic body having light transmissivity.

20. The lens panel of claim 19, wherein the first direction is a column direction, and the second direction is a row direction,
wherein the plurality of first variable lenses have a curvature varying as a fluid is injected to or discharged from the plurality of first variable lenses, and
wherein the plurality of second variable lenses have a curvature varying as the fluid is injected to or discharged from the plurality of second variable lenses.
